(19) United States
(12) Patent Application Publication
(10) Pub. No.: US 2007/0025250 A1
(43) Pub. Date: Feb. 1, 2007

(54) Session relay device and relay method

(75) Inventors: Hideyuki Shimonishi, Minato-ku (JP); Tutomu Murase, Minato-ku (JP); Yasuhiro Yamasaki, Minato-ku (JP); Yohei Hasegawa, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 10/568,439

(22) PCT Filed: Jul. 29, 2004
(86) PCT No.: PCT/JP04/10795

§ 371 Date: Feb. 14, 2006

(30) Foreign Application Priority Data
Aug. 20, 2003 (JP) 2003-295759

(51) Int. Cl. H04L 12/26

(52) U.S. Cl. 370/231

(57) ABSTRACT

Bandwidth control unit (123-1) controls data transfer from reception buffer (122-1) to transmission buffer (124-1). Transmission resumption ACK generation unit (126-1) generates an ACK packet instructing a transmission terminal to resume transmission while duplicate ACK generation unit (127-1) generates a duplicate ACK instructing the transmission terminal to reduce the transmission rate. Packet discarding ratio calculation unit (128-1) obtains a packet discarding ratio in a session to a reception terminal. According to a data amount remaining in the transmission buffer and the packet discarding ratio, control parameter calculation unit (129-1) changes the control parameter of the session to the reception terminal.

### TECHNICAL FIELD

The present invention relates to a session relay device and a session relay method used therefor, and more particularly, to a device for relaying data between TCP (Transmission Control Protocol) sessions.

### BACKGROUND ART

Generally, in communication applications, a communication session (particularly, a TCP session) is established between a transmission terminal and a reception terminal, and a communication is made on the established session.

The communication bandwidth for the TCP session largely varies depending on a congestion level and a round-trip propagation delay time of the network. For example, if there is a round-trip propagation delay of 30 msec, the throughput of the TCP session is calculatively limited to approximately 20 Mbps, even if a physical bandwidth of 1 Gbps is available, on the assumption that a transmission buffer size is 64 KB.

Also, if there is likewise a round-trip propagation delay of 30 msec, a throughput of 1 Gbps cannot be calculatively achieved, even if a sufficient transmission buffer can be ensured, as long as a discarding ratio in a network is not 0.0001% or less, i.e., packets are not discarded at a frequency of once per 26 seconds or less. Further, there is another problem that even if a particular important TCP session requires a bandwidth, the required bandwidth cannot be ensured due to contention with other TCP sessions.

Thus, as technologies for improving the throughput of the TCP session, the following schemes have conventionally existed. A first scheme is a scheme in which a TCP transmission terminal is provided with a sufficient transmission buffer. In this scheme, since a maximum amount of transmissible data is increased even if a reception confirmation packet (ACK packet) is not received, the throughput can be improved in an environment where the product of the bandwidth and propagation delay (bandwidth delay product) is large.

Also, generally, this scheme can readily increase the maximum amount of data by changing a TCP parameter in the operating system (OS). For example, the following Reference 1 discloses a system which permits a transmission terminal to have a transmission buffer of 64 KB or more, and the following Reference 2 discloses a system which automatically changes the amount of transmission buffer depending on the bandwidth, propagation delay and the like.

Reference 1: V. Jacobson et al., “TCP Extensions for High Performance”, Internet Engineering Task Force, Request for comments 1323, May 1992.

Reference 2: Tom Dunigan et at, “A TCP Tuning Daemon”, in proceedings of SC2002, November 2002.

The second scheme is a scheme in which a TCP session is relayed. In this scheme, a session relay device is installed between a transmission terminal and a reception terminal, such that data is relayed between a session from the transmission terminal to the session relay device and a session from the session relay device to the reception terminal. Thus, the throughput can be improved because the bandwidth delay product is smaller in the respective sessions than in a session in which a communication is directly made between the transmission terminal and the reception terminal. Specific examples of this second scheme are disclosed, for example, in the following References 3 to 7.

Reference 3: JP-A-11-252179

Reference 4: JP-A-2002-281104

Reference 5: JP-A-11-112576

Reference 6: JP-A-2002-312261

Reference 7: Ajay Bakre and B. R. Badrinath, “I-TCP; Indirect TCP for Mobile Host”, Department of Computer Science Rutgers University, DSC-TR-314, 1994 (http://www.it.iitb.ac.in/it644/papers/i-tcp.pdf)

A third scheme is a scheme in which a TCP window flow control algorithm is changed. While the bandwidth for a TCP session is determined by a packet discard ratio as well, this scheme performs, in TCP window flow control, operations for increasing a transmission bandwidth, i.e., a congestion window size when no packets are discarded and for reducing the congestion window size upon detection of discarded packets.

It is therefore possible to improve the throughput of TCP by changing TCP parameters such as an increasing amount and a decrease rate of the congestion window size. These systems attempt to improve the throughput by changing the TCP control parameters such as an increasing width and a decrease rate of a congestion window. Specific examples of this third scheme are disclosed, for example, in the following References 8, 9.

Reference 8: Sally Floyd, “High-Speed TCP for Large Congestion Windows”, Internet draft draft-floyd-tcp-highspeed-01.txt, Internet Engineering Task Force, wok in progress, 2002

Reference 9: Panos Gevros et al., “Analysis of a Method for Differentiated TCP Service”, In proc. of GLOBECOM99, pp. 1699-1708, 1999)

Also, the following Reference 10 discloses a system which does not reduce a congestion window when a congestion is detected once, but reduces the congestion window when congestions are detected a plurality of times.

Reference 10: JP-A-11-122296

A fourth scheme is a scheme in which a particular session is provided with a high throughput by adjusting the bandwidth among a plurality of TCP sessions through queuing.

In this scheme, a queue is provided for each session in a session relay device installed between a transmission terminal and a reception terminal, such that incoming packets of each session are stored in a queue corresponding to the session.

Packets are delivered from the respective queues in bandwidths set for the respective sessions, and packets delivered from the transmission terminal in a bandwidth larger than the set bandwidth are discarded in the session relay device. Specific examples of this fourth scheme are disclosed, for example, in the following References 11, 12.

Reference 11: JP-A-10-126446

Reference 12: JP-A-10-233802

A fifth scheme is a scheme in which a particular session is provided with a high throughput by controlling an ACK (acknowledgement) packet in a session relay device installed between a transmission terminal and a reception terminal to adjust the bandwidth among TCP sessions.

In this scheme, the amount of data transmitted from the transmission terminal to the reception terminal is reduced to control the bandwidth by rewriting an advertisement window size written in the ACK packet, i.e., the amount of data which can be received by the reception terminal to be smaller.

Also, this scheme delays the delivery of next data from the transmission terminal by delaying the ACK packet to control the bandwidth. As systems according to this scheme, there are a system which rewrites an ACK packet with congestion information on an ATM (Asynchronous Transfer Mode) network, as disclosed in the following Reference 13, and a system which delays an ACK packet in accordance with the period of a video frame, as disclosed in the following Reference 14.

Reference 13: JP-A-2001-203697

Reference 14: JP-A-2002-271380

The conventional session relay device described above has a problem that terminals must be modified when the first scheme is used. The users themselves must set a buffer size optimal to respective TCP sessions of respective terminals, and moreover, for automatically setting the buffer size, an application program therefor must be added to the terminals, resulting in an increased management cost for the terminals.

When the second scheme is used, the conventional session relay device has a problem of the inability to achieve a high throughput if a packet discarding ratio is high in a network.

For this reason, the conventional session relay device fails to achieve a high throughput even if a plurality of the session relay devices are used to perform a large number of relays between a transmission terminal and a reception terminal only if the packet discarding ratio Is high even at a single site in a particular section.

When the third scheme is used, the conventional session relay device has a problem of causing a congestion in a network in some cases. In the third scheme, since packets are transmitted in a high bandwidth even at the same network congestion level, as compared with TCP having ordinary control parameters, a congestion can be caused in the network.

Particularly, the congestion is more likely to occur as the control parameters are set to more largely Improve the throughput. Since a range of the control parameters which avoid the congestion varies depending on a variety of conditions and cannot be uniquely determined, it cannot be ensured that the congestion is avoided in a network while improving the throughput. On the other hand, when the control parameters are set moderately enough to avoid the congestion, an improved throughput cannot be expected.

Also, when the third scheme is used, the conventional session relay device has a problem of the inability to explicitly control the throughput. The third scheme cannot uniquely determine the control parameters for a target throughput, thus failing to realize the provision of an equally high throughput independently of a propagation delay time to a destination terminal, the provision of a particular throughput to a particular session, and the like.

Further, even if the third scheme is combined with the aforementioned fourth scheme or fifth scheme, the control parameters must have been set such that a target throughput can be achieved in any situation because the fourth scheme or fifth scheme only conducts the control in a direction in which the throughput is degraded. In this event, the network is highly likely to be congested.

When the fourth scheme or fifth scheme is used alone, it cannot conduct explicit bandwidth control, when the bandwidth delay product is large or when the network is congested, due to its inability to conduct the control in a direction in which the throughput is improved.

When the third scheme and fourth scheme are used, the conventional session relay device has a problem that the bandwidth is reduced between the transmission terminal and the session relay device in some cases.

When the bandwidth between the transmission terminal and the session relay device is smaller than the bandwidth between the session relay device and the reception terminal, a reception buffer of the session relay device is frequently filled up, causing the session relay device to notify the transmission terminal of an advertisement window size of zero byte. Upon notification of the advertisement window size of zero byte, the transmission terminal stops the transmission until it is next notified of the advertisement window size of one byte or more, thus resulting in a lower transmission bandwidth from the transmission terminal.

The conventional session relay device has a problem that this problem of lower transmission bandwidth from the transmission terminal also affects between the session relay device and the reception terminal.

When a bandwidth of data which can be processed by the reception terminal is smaller than a bandwidth between the transmission terminal and the session relay device, a reception buffer of the reception terminal is frequently filled up, causing the reception terminal to notify the session relay device of an advertisement window size of zero byte. Upon notification of the advertisement window size of zero byte, the session relay device stops the transmission until it is next notified of the advertisement window size of one byte or more, thus resulting in a lower transmission bandwidth from the session relay device.

### DISCLOSURE OF THE INVENTION

It is therefore an object of the present invention to provide a session relay device which is capable of solving the problems mentioned above, and optimally controlling a bandwidth for a session, while avoiding a congestion, independently of a network congestion situation or a session round-trip propagation delay time, and a session relay method used therefor.

A session relay device according to the present invention is a session relay device for controlling a communication bandwidth between a transmission terminal and a reception terminal by relaying sessions between said transmission terminal and said reception terminal, said session relay device comprising means for changing window flow control for a session between said device itself and said reception terminal.

Another session relay device according to the present invention is a session relay device for realizing a communication between a transmission terminal and a reception terminal by relaying data between a session to said transmission terminal and a session to said reception terminal, said device comprising reception control means for receiving data from the session to said transmission terminal, transmission control means for transmitting data to the session to said reception terminal, means for passing data received and processed by said reception control means to said transmission processing means, observing means for observing a state relating to said transmission control means, and changing means for changing operation of said transmission control means,

wherein the operation of said transmission control means is changed in accordance with the result of the observation of said observing means.

A session relay method according to the present invention is a session relay method for a session relay device for controlling a communication bandwidth between a transmission terminal and a reception terminal by relaying sessions between said transmission terminal and said reception terminal, said method characterized by comprising, on said session relay device side, processing of changing window flow control for a session between said session relay device and said reception terminal.

Another session relay method according to the present invention is a session relay method for a session relay device for realizing a communication between a transmission terminal and a reception terminal by relaying data between a session to said transmission terminal and a session to said reception terminal, said method comprising, on said session relay device side, processing of passing data, which is received and processed by reception control means for receiving data from the session to said transmission terminal, to transmission processing means for transmitting data to a session to said reception terminal; processing of observing a state relating to said transmission control means; and processing of changing operation of said transmission control means, wherein the operation of said transmission control means is changed in accordance with the result of the observation.

Specifically, to solve the problems mentioned above, the session relay device of the present invention controls the throughput by changing the transmission buffer size of the session relay device, a TCP (Transmission Control Protocol) control parameter, and the like without changing the transmission terminal or reception terminal.

Also, to solve the problems mentioned above, the session relay device of the present invention controls the throughput, without being affected by a propagation delay time or a network congestion level, by combining a relay of TCP sessions with a change in the transmission buffer size of the session relay device, the TCP control parameter and the like.

Further, to solve the problems mentioned above, the session relay device of the present invention conducts bandwidth control when data received from a session with a transmission terminal is passed to a session with a reception terminal, and dynamically changes the control parameter in the session for making a transmission to the reception terminal based on the difference between the amount of received data and the amount of actually transmitted data in this session.

In the session relay device of the present invention, for example, the control parameter is changed in a direction in which the throughput increases when the amount of data in the transmission buffer for a session to the reception terminal or an average thereof is equal to or larger than a certain value, while the control parameter is changed in a direction in which the throughput degrades when the data amount or an average thereof is equal to or smaller than the certain value, thereby dynamically changing the control parameter to accomplish the target bandwidth control.

Also, the session relay device of the present invention stops changing the control parameter or changes it in a direction in which the throughput degrades when a throughput improvement effect does not appear even if the control parameter is changed in the direction in which the throughput improves, or when it determines a congestion from the fact that the discarding ratio has increased to a certain value or higher.

To solve the problems mentioned above, the session relay device of the present invention monitors the number of packets staying in the reception buffer for a session between the transmission terminal and the session relay device, and generates a duplicate ACK having the same ACK sequence number to the transmission terminal, when the number of packets or an average value thereof is equal to or larger than a certain value, thereby reducing the transmission rate of the transmission terminal to prevent the reception buffer from being frequently filled up.

Also, in order to resume the transmission earlier even if the reception buffer is filled up, if a certain amount or more of free capacity can be ensured in the reception buffer at the time an ACK packet is received from the reception terminal for confirming the reception of one byte or more, the session relay device of the present invention transmits an ACK packet having an advertisement window size of one or more to the transmission terminal at that time.

To solve the problems mentioned above, the session relay device of the present invention monitors an advertisement window size notified from the reception terminal, and changes the control parameter for a session from the session relay device to the reception terminal if the average of advertisement window size is equal to or larger than a certain value, thereby reducing the transmission rate from the session relay device to prevent the reception buffer from being frequently filled up.

Accordingly, as described above, the present invention can provide an effect of optimally controlling the bandwidth for a session without causing a congestion independently of a network congestion situation or a session round-trip propagation delay time.

### BRIEF DESCRIPTION OF THE DRAWINGS

FIG. 1 is a block diagram illustrating the configuration of a transmission system including a session relay device according to a first embodiment of the present invention.

FIG. 2 is a block diagram illustrating the configuration of the session relay device according to the first embodiment of the present invention.

FIG. 3 is a flow chart illustrating session relay processing according to the first embodiment of the present invention.

FIG. 4 is a flow chart illustrating session relay processing according to the first embodiment of the present invention.

FIG. 5 is a flow chart illustrating ACK return processing according to the first embodiment of the present invention.

FIG. 6 is a flow chart illustrating congestion processing according to the first embodiment of the present invention.

FIG. 7 is a block diagram illustrating the configuration of a session relay device according to a second embodiment of the present invention.

FIG. 8 is a block diagram illustrating the configuration of a session relay device according to a third embodiment of the present invention.

FIG. 9 is a block diagram illustrating the configuration of a session relay device according to a fourth embodiment of the present invention.

FIG. 10 is a block diagram illustrating the configuration of a session relay device according to a fifth embodiment of the present invention.

FIG. 11 is a block diagram illustrating the configuration of a session relay device according to a sixth embodiment of the present invention.

FIG. 12 is a block diagram illustrating the configuration of a session relay device according to a seventh embodiment of the present invention.

FIG. 13 is a block diagram illustrating the configuration of a session relay device according to an eighth embodiment of the present invention.

FIG. 14 is a block diagram illustrating a flow of data between a session relay device (transmission terminal) and a session relay device (reception terminal) in the eighth embodiment of the present invention.

### BEST MODE FOR CARRYING OUT THE INVENTION

Next, embodiments of the present invention will be described with reference to the drawings.

[First Embodiment]

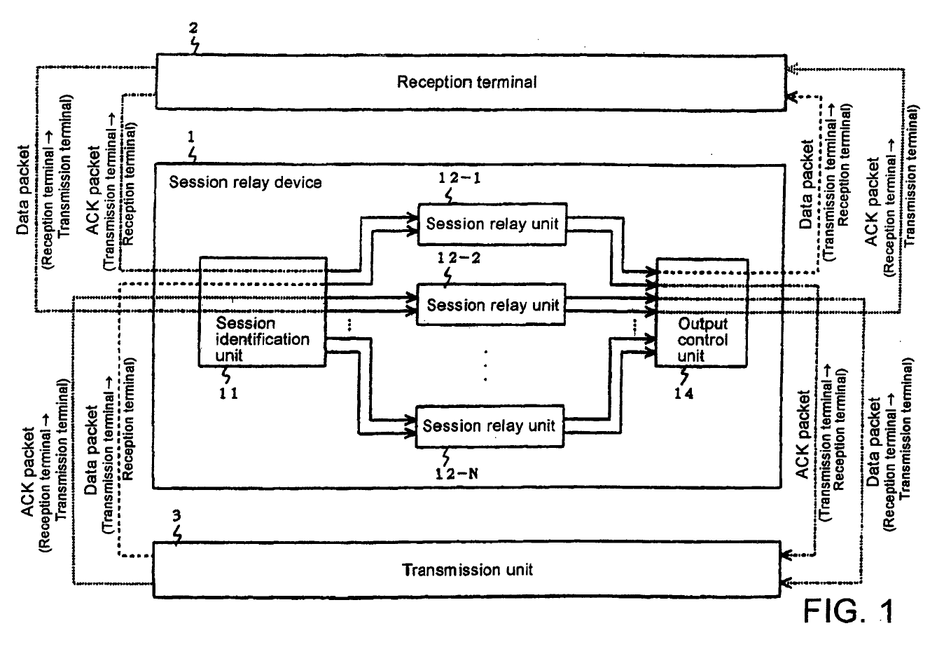

FIG. 1 is a block diagram illustrating the configuration of a transmission system which includes a session relay device according to a first embodiment of the present invention. In FIG. 1, session relay device 1 comprises session identification unit 11, session relay units 12-1 to 12-N, and output control unit 13, and is connected to reception terminal 2 and transmission terminal 3.

First, when data is sent from transmission terminal 3 to reception terminal 2, a data packet from transmission terminal 3 is processed by a reception session processing unit (not shown) of session relay unit 12-1, and as a result, an ACK packet is returned to transmission terminal 3.

Data received by the reception session processing unit is sent to a transmission session processing unit (not shown) of session relay unit 12-1, and a data packet is transmitted from here to reception terminal 2. On the other hand, the ACK packet returned by reception terminal 2 is processed by the transmission session processing unit of session relay unit 12-1.

Likewise, when data is sent from reception terminal 2 to transmission terminal 3, a data packet from reception terminal 2 is processed by a reception session processing unit (not shown) of session relay unit 12-2, and as a result, an ACK packet is returned to reception terminal 2.

The data received by the reception session processing unit is sent to a transmission session processing unit (not shown) of session relay unit 12-2, and a data packet is transmitted from here to transmission terminal 3. On the other hand, the ACK packet returned by transmission terminal 3 is processed by the transmission session processing unit of session relay unit 12-2.

In this embodiment, the throughput is controlled by changing a transmission buffer size of session relay device 1, TCP (Transmission Control Protocol) control parameters, and the like, without modifying transmission terminal 3 or reception terminal 2.

Also, in this embodiment, the throughput is controlled without affected by a propagation delay time or a network congestion level by combining a TCP session relay with a change in the transmission buffer size of session relay device 1, TCP control parameters, and the like.

Further, in the embodiment of the present invention, the bandwidth is controlled when data received from a session with transmission terminal 3 is passed to a session with reception terminal 2, and in a session for making a transmission to reception terminal 2, control parameters are dynamically changed for the session based on a difference between the amount of received data and the amount of actually transmitted data.

In this embodiment, the control parameters are changed in a direction in which the throughput increases, for example, when the amount of data in a transmission buffer for a session to reception terminal 2 or an average thereof reaches a certain value or more, while the control parameters are changed in a direction in which the throughput degrades when the amount of data or its average falls below the certain value, thereby dynamically changing the control parameters to conduct target bandwidth control.

In this embodiment, when the throughput improving effect does not appear even if the control parameters are changed in the direction in which the throughput improves, or when a congestion is determined from a discarding ratio which has increased to a certain value or more, the control parameters are not changed or changed in a direction in which the throughput degrades.

In this embodiment, the number of packets staying in a reception buffer of a session between transmission terminal 3 and session relay device 1 is monitored, and a duplicate ACK having the same ACK sequence number is delivered to the transmission terminal when the number of packets or an average value thereof reaches a certain value or more, thereby reducing the transmission rate of transmission terminal 3 to prevent the reception buffer from being frequently filled up.

Also, in this embodiment, in order to resume the transmission earlier even when the reception buffer is filled up, if a certain amount or more of free capacity can be ensured in the reception buffer at the time an ACK packet has been received from reception terminal 2 for confirming the reception of one byte or more, an ACK packet having an advertisement window size of one or more is transmitted to transmission terminal 3 at that time.

In this embodiment, the advertisement window size notified from reception terminal 2 is monitored to change the control parameters for a session from session relay device 1 to reception terminal 2 when the average of the advertisement window size is equal to or more than a certain value, thereby reducing the transmission rate from session relay device 1 to prevent the reception buffer from being frequently filled up.

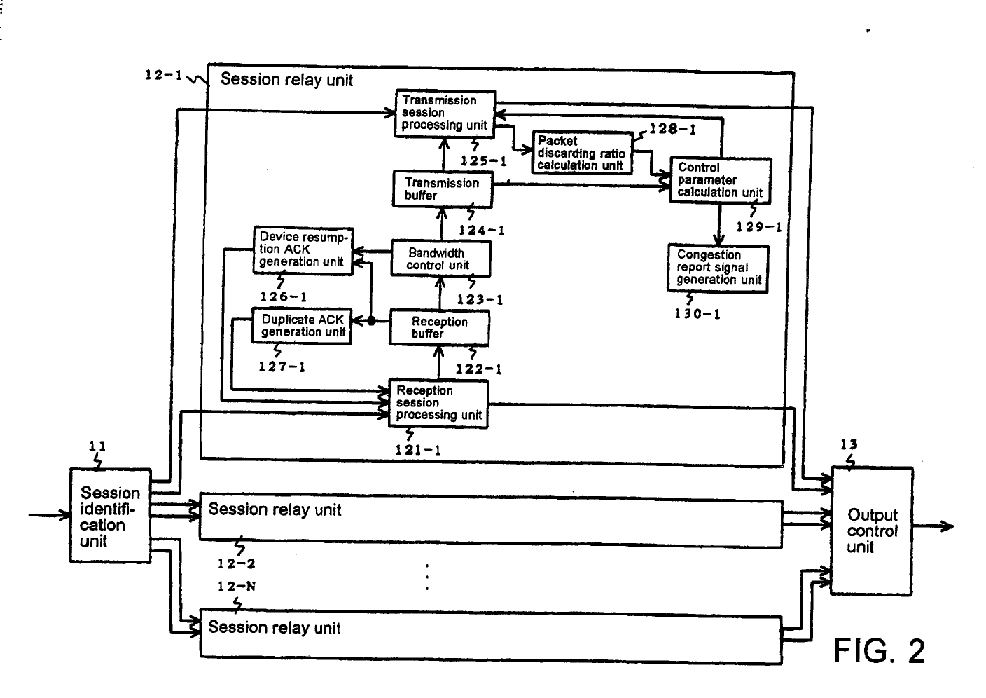

FIG. 2 is a block diagram illustrating the configuration of the session relay device according to the first embodiment of the present invention. In FIG. 2, the session relay device according to the first embodiment of the present invention comprises session identification unit 11, session relay units 12-1 to 12-N, and output control unit 13, and is connected to reception terminal 2 and transmission terminal 3.

Session identification unit 11 determines a session to which an incoming packet belongs, and session relay unit 12-1 to 12-N relays between a session with session identification unit 11 and transmission terminal 3 and a session 4j with reception terminal 2. Output control unit 13 delivers packets delivered from each of session relay units 12-1 to 12-N to an output line.

Session relay units 12-1 to 12-N comprise reception session processing units 121-1 to 121-N (reception session processing units 121-2 to 121-N are not shown); reception buffers 122-1 to 122-N (reception buffers 122-2 to 122-N are not shown); bandwidth control units 123-1 to 123-N (bandwidth control units 123-2 to 123-N are not shown); transmission buffers 124-1 to 124-N (transmission buffers 124-2 to 124-N are not shown); transmission session processing units 125-1 to 125-N (transmission session processing units 125-2 to 125-N are not shown); transmission resumption ACK (acknowledgement) generation units 126-1 to 126-N (transmission resumption ACK generation units 126-2 to 126-N are not shown); duplicate ACK generation units 127-1 to 127-N (duplicate ACK generation units 127-2 to 127-N are not shown); packet discarding ratio calculation units 128-1 to 128-N (packet discarding ratio calculation units 128-2 to 128-N are not shown); control parameter calculation units 129-1 to 129-N (control parameter calculation units 129-2 to 129-N are not shown); and congestion report signal detection units 130-1 to 130-N (congestion report signal detection units 130-2 to 130-N are not shown).

Reception session processing unit 121-1 to 121-N processes a session for receiving data from transmission terminal 3, and reception buffer 122-1 to 122-N temporarily stores received data. Bandwidth control unit 123-1 to 123-N controls a data movement from reception buffer 122-1 to 122-N to transmission buffer 124-1 to 124-N, and transmission buffer 124-1 to 124-N temporarily stores data to be transmitted. Transmission session processing unit 125-1 to 125-N processes a session for transmitting data to reception terminal 2.

Transmission resumption ACK generation unit 126-1 to 126-N generates an ACK packet for instructing transmission terminal 3 to resume a transmission, and duplicate ACK generation unit 127-1 to 127-N generates a duplicate ACK packet for instructing transmission terminal 3 to reduce the transmission rate.

Packet discarding ratio calculation unit 128-1 to 128-N calculates a packet discarding ratio in a session to reception terminal 2, and control parameter calculation unit 129-1 to 129-N changes control parameters for a session to reception terminal 2 from the amount of data staying in transmission buffer 124-1 to 124-N and the packet discarding ratio. Congestion report signal detection unit 130-1 to 130-N notifies that a set bandwidth cannot be satisfied by a congestion in a network (not shown).

In a TCP (Transmission Control Protocol) session, bidirectional communications are generally made between transmission terminal 3 and reception terminal 2. Thus, assume in this embodiment that two of session relay units 12-1 to 12-N are used for a set of transmission terminal 3 and reception terminal 2, and corresponding session relay units 12-1 to 12-N are used respectively for data communications in the respective directions.

Therefore, session relay units 12-1 to 12-N are provided two by two for a plurality of sets of transmission terminals 3 and reception terminals 2, and each of session relay units 12-1 to 12-N performs processing for relaying data from a session from different transmission terminal 3 to a session to corresponding reception terminal 2, or from a session from different reception terminal 2 to a session to corresponding transmission terminal 3.

In the TCP session, a data packet in a certain direction and an ACK packet in a direction opposite thereto can be integrated onto a single packet (piggy back of ACK), but a description on such an operation is omitted in this embodiment for simplifying the description.

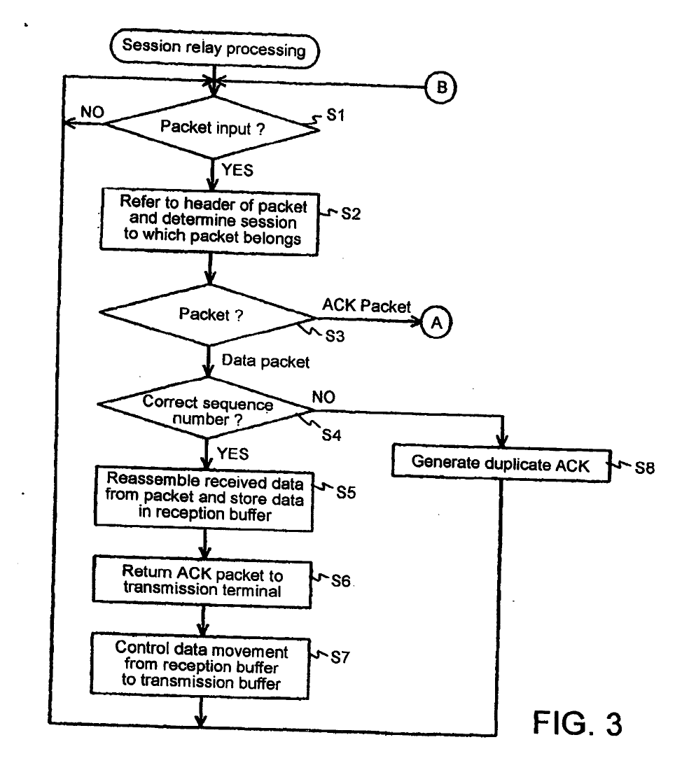

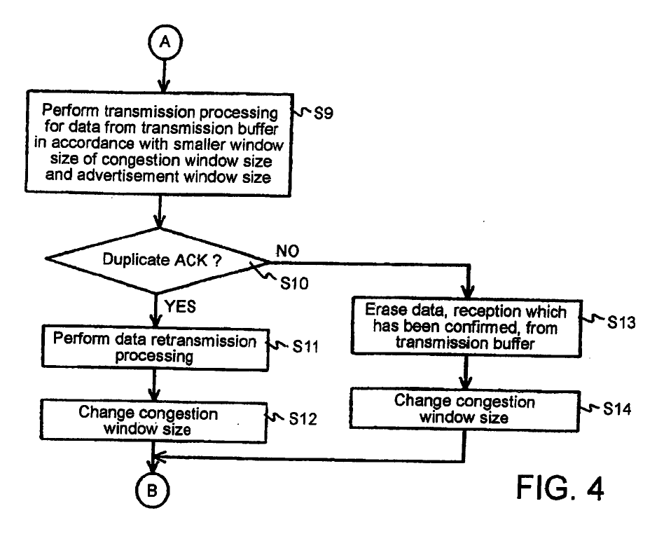

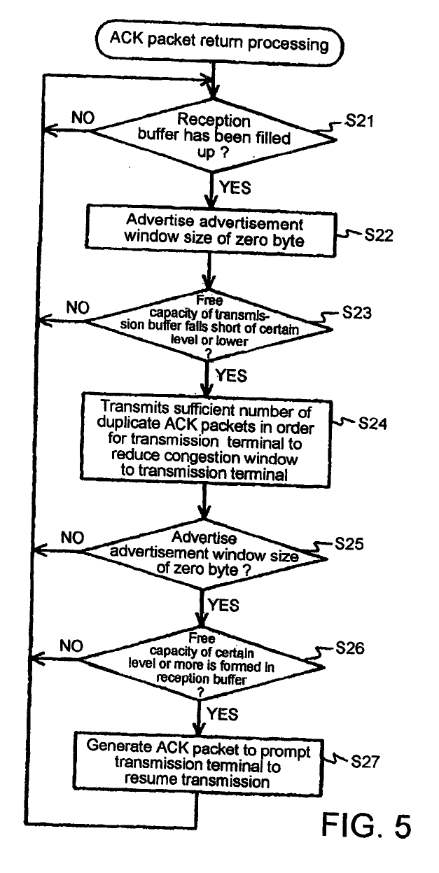

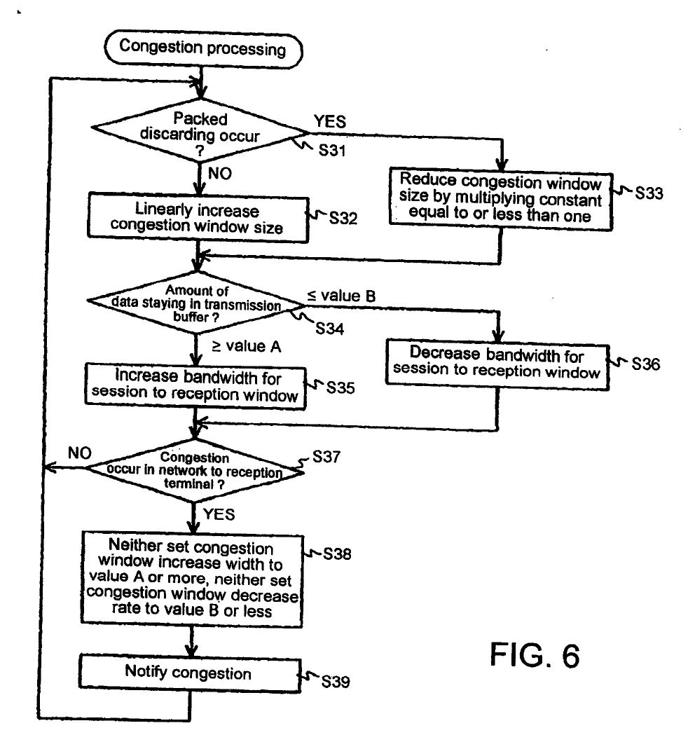

FIGS. 3 and 4 are flow charts illustrating the session relay processing according to the first embodiment of the present invention, FIG. 5 is a flow chart illustrating ACK return processing according to the first embodiment of the present invention, and FIG. 6 is a flow chart illustrating congestion processing according to the first embodiment of the present invention. The operation of session relay device 1 according to the first embodiment of the present invention will be described with reference to these FIGS. 2 to 6.

As a packet is fed to session relay device 1 (step S1 in FIG. 3), session identification unit 11 refers to a header of the packet, and determines a session to which the incoming packet belongs, based on a source IP (Internet Protocol) address, a destination IP address, a fourth-layer protocol number, a source fourth-layer port number, a destination fourth-layer port number, and the like (step S2 in FIG. 3).

Session identification unit 11 passes the packet to reception session processing unit 121-1 to 121-N of corresponding session relay unit 12-1 to 12-N when the incoming packet is a data packet (step S3 in FIG. 3), and to a transmission session processing unit 125-1 to 125-N of corresponding session relay unit 12-1 to 12-N when the incoming packet is an ACK packet (step S3 in FIG. 3).

When a received data packet has a correct sequence number (step S4 in FIG. 3), reception session processing unit 121-1 to 121-N reassembles received data from the packet and stores the data in reception buffer 122-1 to 122-N (step S5 in FIG. 3), and, at the same time, returns an ACK packet for notifying transmission terminal 3 of the acknowledgement of data reception and an advertisement window size (step S6 in FIG. 3).

When the incoming data packet does not have a correct sequence number (step S4 in FIG. 3), reception session processing unit 121-1 to 121-N generates a duplicate ACK to prompt transmission terminal 3 to retransmit the packet (step S5 in FIG. 3).

Since the foregoing processing is described in detail in “TCP/IP Illustrated, Volume 1: The Protocols,” Addison-Wesley, 1994, ISBN 0-201-63346-9 (hereinafter called “Document 1”), a description thereon will not be made in detail here.

Bandwidth control unit 123-1 to 123-N controls a data movement from reception buffer 122-1 to 122-N to transmission buffer 124-1 to 124-N (step S7 In FIG. 3). This data movement control involves, for example, controlling a bandwidth for the data movement in accordance with a target bandwidth set for each session, or cyclically scheduling data movements among bandwidth control units 123-1 to 123-N such that all bandwidth control units 123-1 to 123-N perform data movements in equal bandwidths or in a preset bandwidth ratio. In this event, bandwidth control unit 123-1 to 123-N temporarily stops a data movement if there is no data in reception buffer 122-1 to 122-N or if there is no free capacity in transmission buffer 124-1 to 124-N.

Transmission session processing unit 125-1 to 125-N performs transmission processing for data from transmission buffer 124-1 to 124-N in accordance with a smaller window size of a congestion window size calculated thereby and an advertisement window size notified from reception terminal 2 (step S9 in FIG. 4).

Also, upon receipt of an ACK packet from reception terminal 2, transmission session processing unit 125-1 to 125-N performs data retransmission processing (S11 in FIG. 4) and simultaneously changes the congestion window size (S12 in FIG. 4) when the ACK packet is a duplicate ACK (step S10 in FIG. 4).

When the ACK packet from reception terminal 2 is not a duplicate ACK (step S10 in FIG. 4), transmission session processing unit 125-1 to 125-N erases data, the reception which has been confirmed, from transmission buffer 124-1 to 124-N (step S13 in FIG. 4), and changes the congestion window size (step S14 in FIG. 4). Since this processing is also described In detail in Document 1, a description thereon is not made in detail.

If the reception buffer has been filled up (step S21 in FIG. 5) when the ACK packet is returned to transmission terminal 3, reception session processing unit 121-1 to 121-N advertises an advertisement window size of zero byte (step S22 in FIG. 5), thus causing transmission terminal 3 to stop transmitting upon receipt of this ACK packet.

Accordingly, in session relay device 1 according to this embodiment, the free capacity of transmission buffer 122-1 to 122-N falls short of a certain level or lower (step S23 in FIG. 5), duplicate ACK generation unit 127-1 to 127-N transmits a sufficient number (generally, “3”) of duplicate ACK packets in order a for transmission terminal 3 to reduce the congestion window to transmission terminal 3 (step S24 in FIG. 5) immediately or each time a packet is received, causing transmission terminal 3 to reduce the data output rate.

Also, in session relay device 1 according to the present invention, an ACK packet is immediately generated to prompt transmission terminal 3 to resume the transmission (step S27 in FIG. 5) when a free capacity of a certain value (MSS; Maximum Segment Size) or more is available in reception buffer 122-1 to 122-N (steps S25, S26 in FIG. 5), such that transmission terminal 3 can resume the data transmission at an earlier stage even when it is advertised of an advertisement window size of zero byte.

Thus, when data is moved from reception buffer 122-1 to 122-N to transmission buffer 124-1 to 124-N by bandwidth control unit 123-1 to 123-N, transmission resumption ACK generation unit 126-1 to 126-N examines reception buffer 122-1 to 122-N for a free capacity, and generates an ACK packet for transmission to transmission terminal 3 if the free capacity has recovered to a certain value or more.

A bandwidth from session relay device 1 to reception terminal 2 depends on the congestion window size calculated by transmission session processing unit 125-1 to 125-N, and the bandwidth increases as the congestion window size is larger.

The congestion window size is calculated by a TCP window flow control algorithm, wherein the congestion window size is linearly increased when packets are correctly received without discarding any packet (steps S31, S32 in FIG. 6), while the congestion window size is multiplied by a constant equal to or less than one to be reduced when packets have been discarded (steps S31, S33 in FIG. 6).

In this embodiment, the former is referred to as a congestion window increase width, and the latter as a congestion window decrease rate. In this embodiment, these control parameters are dynamically changed to control a bandwidth for a session to reception terminal 2 to be equal to a set bandwidth. Since data is moved within the set bandwidth from bandwidth control unit 123-1 to 123-N to transmission buffer 124-1 to 124-N, an increase in the amount of data staying in transmission buffer 124-1 to 124N means that a bandwidth for a session to reception terminal 2 is smaller than the set bandwidth. Conversely, a decrease in the amount of staying data means that the bandwidth for the session to reception terminal 2 is larger than the set bandwidth.

Therefore, in this embodiment, when the amount of data staying in transmission buffer 124-1 to 124-N increases to predefined certain value A or more (step S34 in FIG. 6), a bandwidth for a session to the reception terminal is increased by increasing the congestion window increase width or reducing the congestion window decrease rate, or both (step S35 in FIG. 6).

Also, in this embodiment, when the amount of data staying in transmission buffer 124-1 to 124-N falls to another predefined certain value B or less (step S34 in FIG. 6), the bandwidth to a session to reception terminal 2 is reduced by reducing the congestion window increase width or increasing the congestion window decrease rate, or both (step S36 in FIG. 6).

When it is determined that the set bandwidth cannot be satisfied however the control parameters are changed (step S37 in FIG. 6) due to a congestion occurring in a network to reception terminal 2 (step S37 in FIG. 6), i.e., when the packet discarding ratio on a session to reception terminal 2, calculated by packet discarding ratio calculation unit 128-1 to 128-N, is equal to or higher than a certain value, or when the congestion window increase width is equal to or more than a certain value, or when the congestion window reduction width is equal to or less than a certain value, or when retransmitted packets are discarded and the retransmission times out, the congestion window increase width is not set to certain value A or more, and the congestion window decrease rate is not either set to certain value B or less (step S38 in FIG. 6).

In this event, bandwidth control unit 123-1 to 123-N notifies a manager of this session relay device, a management system or the like of the congestion from congestion report signal generation unit 130-1 to 130-N in expectation of resetting of the set bandwidth or resetting of a route (step S39 in FIG. 6).

[Second Embodiment]

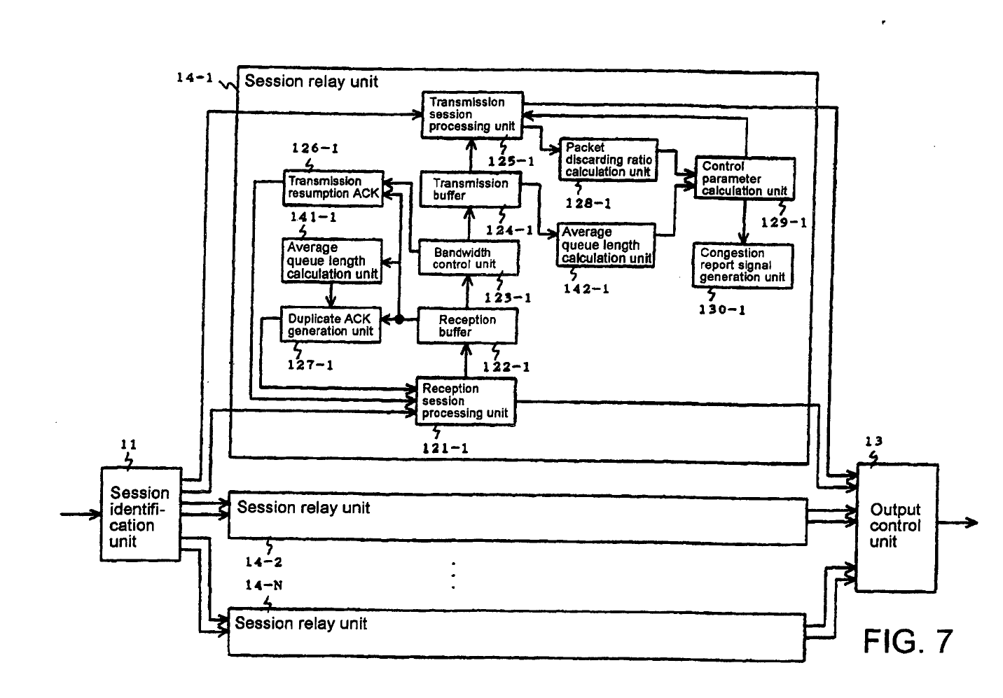

FIG. 7 is a block diagram illustrating the configuration of a session relay device according to a second embodiment of the present invention. In FIG. 7, session relay units 14-1 to 14-N of the session relay device according to the second embodiment of the present invention are similar in configuration to the first embodiment of the present invention illustrated in FIG. 2 except that average queue length calculation units 141-1 to 141-N, 142-1 to 142-N (average queue length calculation units 141-2 to 141-N, 142-2 to 142-N are not shown) are respectively added thereto, and the same components are designated the same reference numerals. Also, the operation of the same components is similar to the first embodiment of the present invention.

Average queue length calculation unit 141-1 to 141-N calculates the amount of average data staying in reception buffer 122-1 to 122-N, while average queue length calculation unit 142-1 to 142-N calculates the amount of average data staying in transmission buffer 124-1 to 124-N.

The operation of the session relay device according to the second embodiment of the present invention will be described with reference to this FIG. 7. The following description will be given only of aspects in the second embodiment of the present invention different from the first embodiment of the present invention.

In the first embodiment of the present invention, duplicate ACK generation unit 127-1 to 127-N determines the generation of a duplicate ACK based on a free capacity of reception buffer 122-1 to 122-N, whereas in this embodiment, the generation of a duplicate ACK is determined on the basis of the amount of average data staying in the reception buffer, calculated by average queue length calculation unit 141-1 to 141-N.

Also, in the first embodiment of the present invention, control parameter calculation unit 129-1 to 129-N updates the control parameters based on the amount of data staying in transmission buffer 124-1 to 124-N, whereas in this embodiment, the control parameters are updated on the bases of the amount of average data staying in the transmission buffer calculated by average queue length calculation unit 142-1 to 142-N.

[Third Embodiment]

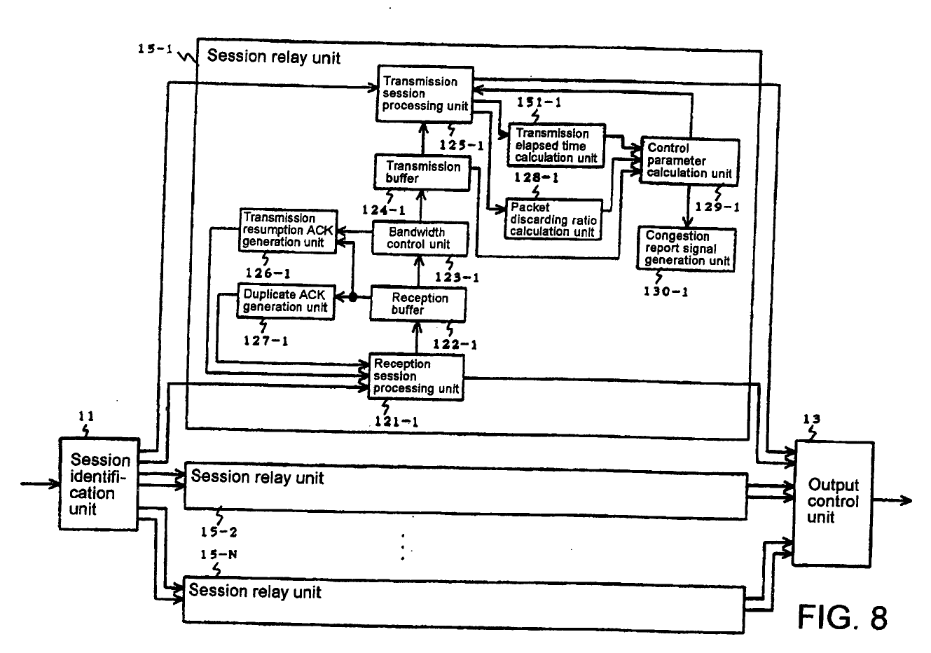

FIG. 8 is a block diagram illustrating the configuration of a session relay device according to a third embodiment of the present invention. In FIG. 8, session relay units 15-1 to 15-N of the session relay device according to the third embodiment of the present invention are similar in configuration to the first embodiment of the present invention illustrated in FIG. 2 except that transmission elapsed time calculation units 151-1 to 151-N (transmission lapsed time calculation units 151-2 to f51-N are not shown) are respectively added thereto, and the same components are designated the same reference numerals. Also, the operation of the same components is similar to the first embodiment of the present invention.

Transmission elapsed time calculation unit 151-1 to 151-N calculates an elapsed time from the time a data transmission is started in transmission session processing unit 125-1 to 125-N, and passes the calculated value to control parameter calculation unit 129-1 to 129-N.

The operation of session relay device according to the third embodiment of the present invention will be described with reference to FIG. 8. The following description will be given only of aspects in the third embodiment of the present invention different from the first embodiment of the present invention.

In the first embodiment of the present invention, the control parameters used by transmission session processing unit 125-1 to 125-N are determined from the amount of data staying in the transmission buffer and the packet discarding ratio, whereas this embodiment additionally uses the elapsed time from the start of a data transmission.

Specifically, for increasing a bandwidth for a session to reception terminal 2, the congestion window increase width is changed in preference to the decrease rate to improve the follow-up characteristic of the bandwidth control for short data if a short time has elapsed from the start of data, whereas the congestion window decrease rate is changed in preference to the increase width to stabilize the bandwidth control if a long time has elapsed from the start of data.

The transmission elapsed time calculated by transmission elapsed time calculation unit 151-1 to 151-N is reset to zero when a new communication is started, i.e., when the congestion window of the TCP session starts operating at low speeds.

[Fourth Embodiment]

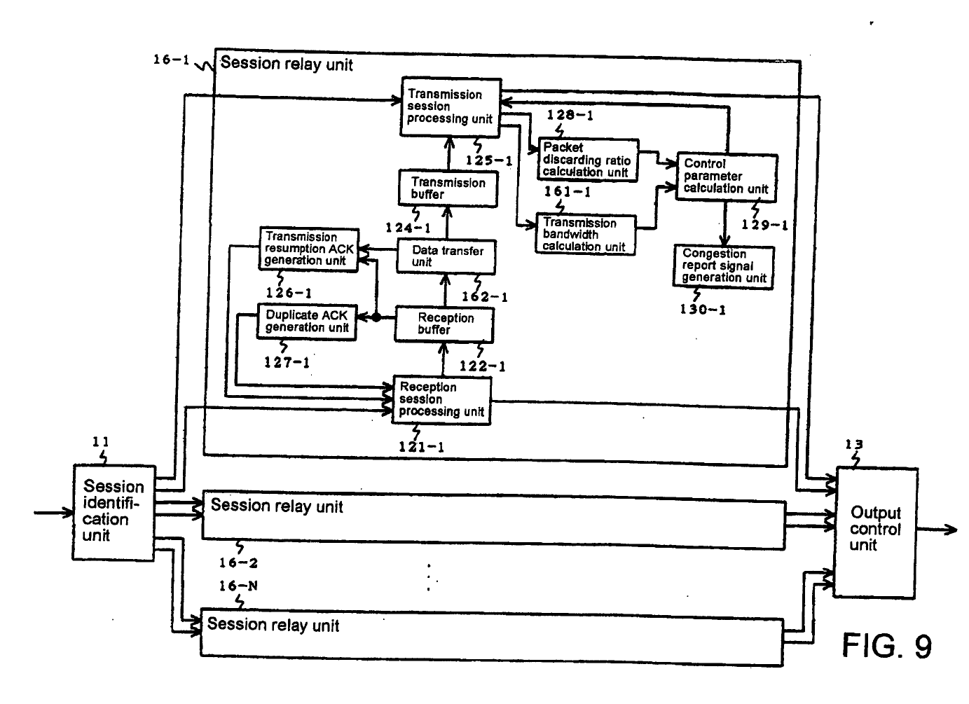

FIG. 9 is a block diagram illustrating the configuration of a session relay device according to a fourth embodiment of the present Invention. In FIG. 9, session relay units 16-1 to 16-N of the session relay device according to the fourth embodiment of the present invention are similar in configuration to the first embodiment of the present invention illustrated in FIG. 2 except that transmission bandwidth calculation units 161-1 to 161-N (transmission bandwidth calculation units 161-2 to 161-N are not shown) are respectively added thereto, and data transfer units 162-1 to 162-N (data transfer units 162-2 to 162-N are not shown) are provided instead of bandwidth control units 123-1 to 123-N, and the same components are designated the same reference numerals. Also, the operation of the same components is similar to the first embodiment of the present invention.

Transmission bandwidth calculation unit 161-1 to 161-N measures a data transmission bandwidth from session relay device 1 to reception terminal 2, and passes the measured value to control parameter calculation unit 129-1 to 129-N.

The operation of the session relay device according to the fourth embodiment of the present invention will be described with reference to this FIG. 9. The following description will be given only of aspects in the fourth embodiment of the present invention different from the first embodiment of the present invention.

In the first embodiment of the present invention, a data transfer from reception buffer 122-1 to 122-N to transmission buffer 124-1 to 124-N is controlled by bandwidth control unit 123-1 to 123-N, whereas in this embodiment, data stored in reception buffer 122-1 to 122-N is immediately transferred to transmission buffer 124-1 to 124-N by data transfer unit 162-1 to 162-N.

Therefore, in this embodiment, the bandwidth control Is not conducted through the data transfer, but the bandwidth control is conducted by changing the control parameters for a session to reception terminal 2 based on a transmission bandwidth for the session calculated by transmission bandwidth calculation unit 161-1 to 161-N.

Specifically, in this embodiment, a bandwidth for a session from session relay device 1 to reception terminal 2 is calculated in transmission bandwidth calculation unit 161-1 to 161-N, and if this bandwidth is smaller than a target bandwidth or an (weighted) average bandwidth for all sessions, the bandwidth for the session to reception terminal 2 is increased by increasing the congestion window increase width or reducing the congestion window decrease rate, or both.

Otherwise, in this embodiment, the bandwidth for the session to reception terminal 2 is reduced by reducing the congestion window increase width or increasing the congestion window decrease rate, or both. Transmission bandwidth calculation unit 161-1 to 16 1-N observes an ACK packet from reception terminal 2, and calculates the transmission bandwidth based on the number of bytes, the reception of which has been confirmed per unit time.

Also, in this embodiment, when data is moved from reception buffer 122-1 to 122-N to transmission buffer 124-1 to 124-N, data transfer unit 162-1 to 162-N, rather than bandwidth control unit 123-1 to 123-N examines reception buffer 122-1 to 122-N for a free capacity to generate a transmission resumption ACK.

[Fifth Embodiment]

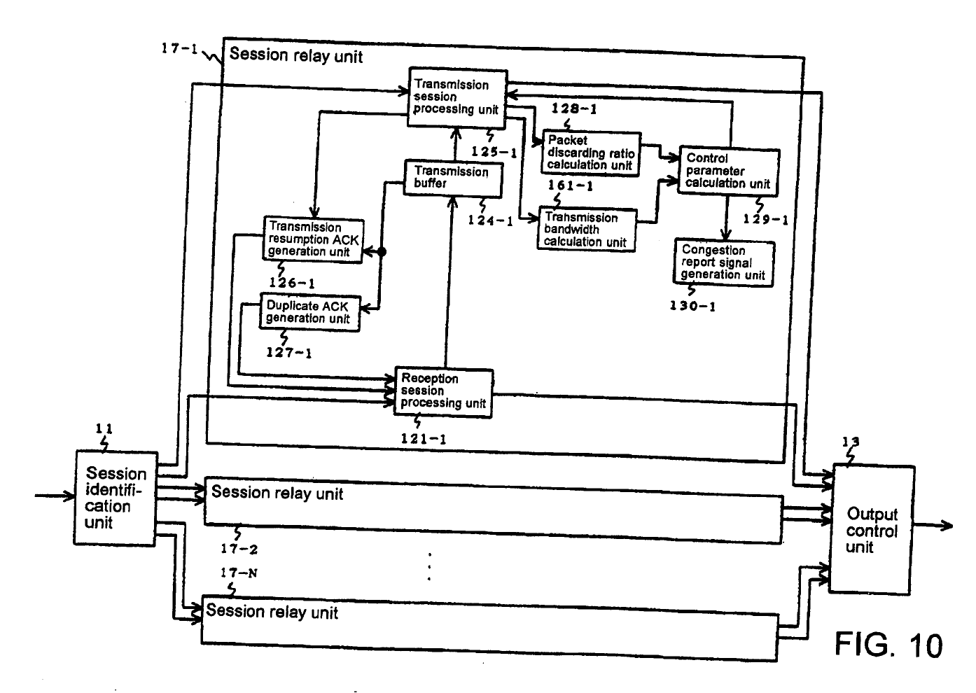

FIG. 10 is a block diagram illustrating the configuration of a session relay device according to a fifth embodiment of the present invention. In FIG. 10, session relay units 17-1 to 17-N of the session relay device according to the fifth embodiment of the present invention are similar in configuration to the fourth embodiment of the present invention illustrated in FIG. 9 except that reception buffers 122-1 to 122N and data transfer units 162-1 to 162-N are removed such that reception session processing units 121-1 to 121-N directly write data into transmission buffers 124-1 to 124-N, respectively, and the same components are designated the same reference numerals. Also, the operation of the same components is similar to the fourth embodiment of the present invention.

The operation of the session relay device according to the fifth embodiment of the present invention will be described with reference to this FIG. 10. The following description will be given only of aspects in the fifth embodiment of the present invention different from the fourth embodiment of the present invention.

In the fourth embodiment of the present invention, data received in reception session processing unit 121-1 to 121-N is written into transmission buffer 124-1 to 124N through reception buffer 122-1 to 122-N and data transfer unit 162-1 to 162-N, whereas in this embodiment, data received in reception session processing unit 121-1 to 121-N is directly written into transmission buffer 124-1 to 124-N.

A data transfer from reception buffer 122-1 to 122-N to transmission buffer 124-1 to 124-N is controlled by data transfer unit 162-1 to 162-N, however, in this embodiment, data received in reception session processing unit 121-1 to 121-N is immediately transferred to transmission buffer 124-1 to 124-N.

For this purpose, in this embodiment, the bandwidth control is conducted by changing the control parameters for a session to reception terminal 2 based on a bandwidth for the session calculated in transmission bandwidth calculation unit 161-1 to 161-N in a manner similar to the fourth embodiment of the present invention.

Also, in this embodiment, since data is directly written from reception session processing unit 121-1 to 121-N into transmission buffer 124-1 to 124-N, a free capacity of transmission buffer 124-1 to 124-N is advertised for the advertisement window size which is notified to transmission terminal 3. Further, in this embodiment, duplicate ACK generation unit 127-1 to 127-N generates a duplicate ACK in accordance with the free capacity of transmission buffer 124-1 to 124-N.

Moreover, in this embodiment, when an ACK packet is received from a session to reception terminal 2, a transmission resumption ACK is generated for transmission terminal 3. Specifically, in this embodiment, when transmission buffer 124-1 to 124-N is filled up so that transmission terminal 3 is being advertised of an advertisement window of zero byte, if session relay device 1 receives a reception confirmation ACK from reception terminal 2, data confirmed by this ACK is removed from transmission buffer 124-1 to 124-N, resulting in a free capacity available in transmission buffer 124-1 to 124-N.

In this event, transmission session processing unit 125-1 to 126-N sends a buffer capacity confirmation signal to transmission resumption ACK generation unit 126-1 to 126-N. Upon receipt of this signal, transmission resumption ACK generation unit 126-1 to 126-N examines a transmission buffer capacity, and generates ACK for transmission resumption which is notified to transmission terminal 3 if transmission buffer 124-1 to 124-N has a free capacity equal to or more than a certain value. On the other hand, in the fourth embodiment of the present invention, when data transfer unit 162-1 to 162-N, rather than bandwidth control unit 123-1 to 123-N, moves data from reception buffer 122-1 to 122-N to transmission buffer 124-1 to 124-N, reception buffer 122-1 to 122-N is examined for a free capacity to generate a transmission resumption ACK.

[Sixth Embodiment]

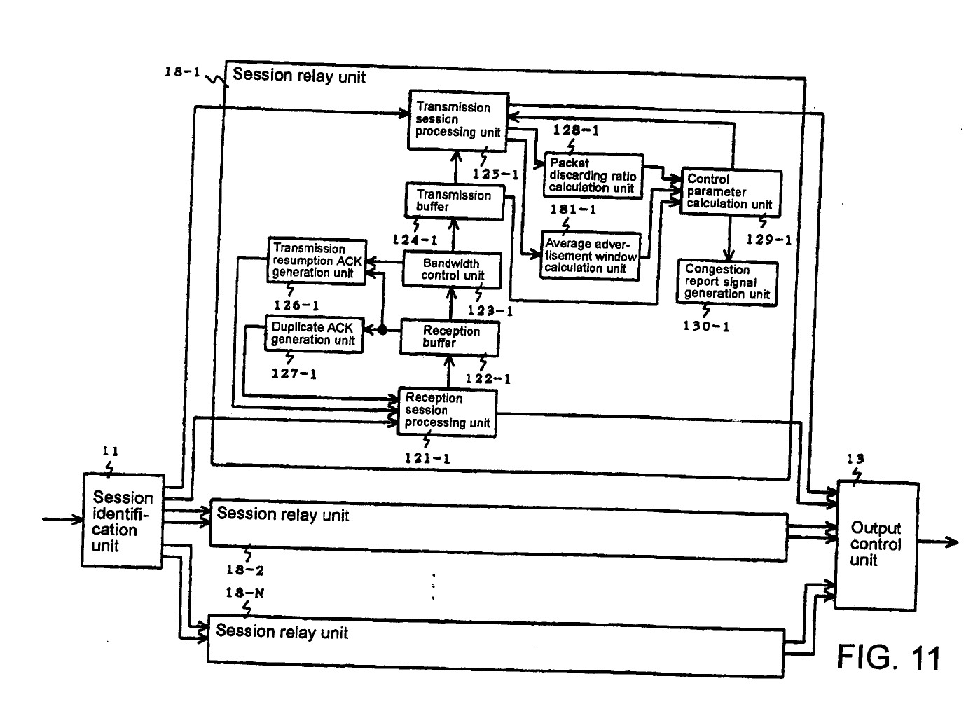

FIG. 11 is a block diagram Illustrating the configuration of a session relay device according to a sixth embodiment of the present invention. In FIG. 11, session units 18-1 to 18-N of the session relay device according to the sixth embodiment of the present invention are similar in configuration to the first embodiment of the present invention illustrated in FIG. 2 except that average advertisement window calculation units 181-1 to 181-N (average advertisement window calculation units 181-2 to 181-N are not shown) are added thereto, and the same components are designated the same reference numerals. Also, the operation of the same components is similar to the first embodiment of the present invention.

The operation of the session relay device according to the sixth embodiment of the present invention will be described with reference to this FIG. 11. The following description will be given only of aspects in the sixth embodiment of the present invention different from the first embodiment of the present invention.

In this embodiment, when the control parameters are calculated for a session to reception terminal 2i control parameter calculation unit 129-1 to 129-N uses an advertisement window size notified from reception terminal 2. Specifically, in this embodiment, the average of advertisement window sizes notified from reception terminal 2 is calculated in average advertisement window calculation unit 181-1 to 181-N at all times, to reduce a bandwidth for a session to reception terminal 2 by reducing the congestion window increase width or increasing the congestion window decrease rate, or both, if the average of the advertisement window size is equal to or larger than a predefined threshold.

[Seventh Embodiment]

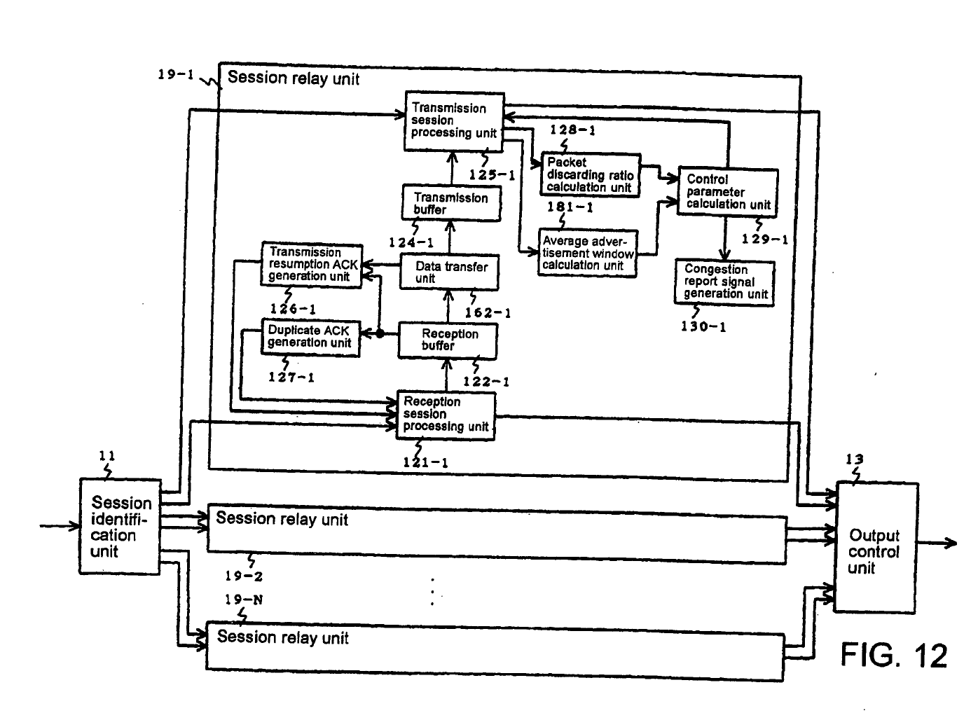

FIG. 12 is a block diagram illustrating the configuration of a session relay device according to a seventh embodiment of the present invention. In FIG. 12, session relay units 19-1 to 19-N of the session relay device according to the seventh embodiment of the present invention are similar in configuration to the fourth embodiment of the present invention illustrated in FIG. 9 except that average advertisement window calculation units 181-1 to 181-N are provided instead of transmission bandwidth calculation units 161-1 to 161-N, and the same components are designated the same reference numerals. Also, the operation of the same components is similar to the fourth embodiment of the present invention.

In the first to sixth embodiments of the present invention described above, session relay device 1 controls a bandwidth between transmission terminal 3 and reception terminal 2 in accordance with a set bandwidth, whereas in this embodiment, no set bandwidth is provided, but the bandwidth is controlled between transmission terminal 3 and reception terminal 2 with an aim at a bandwidth which can be received by reception terminal 2.

The operation of the session relay device according to the seventh embodiment of the present invention will be described with reference to this FIG. 12. The following description will be given only of aspects in the seventh embodiment of the present invention different from the fourth embodiment of the present invention.

In this embodiment, when control parameter calculation unit 129-1 to 129-N calculates the control parameters for a session to reception terminal 2, the control parameters are not changed in accordance with a bandwidth for the session to reception terminal 2, but the control parameters are changed in accordance with an advertisement window size notified from reception terminal 2.

Specifically, in this embodiment, the average of advertisement window size notified from reception terminal 2 is calculated in average advertisement window calculation unit 181-1 to 181-N at all times to reduce the bandwidth for the session to reception terminal 2 by reducing the congestion window increase width or increasing the congestion window decrease rate, or both, if the average of the advertisement window size is equal to or larger than a predefined threshold.

Further, in this embodiment, If the average of the advertisement window size is equal to or smaller than another predefined threshold, the bandwidth for the session to reception terminal 2 is increased by increasing the congestion window increase width, or reducing the congestion window decrease rate, or both.

[Eighth Embodiment]

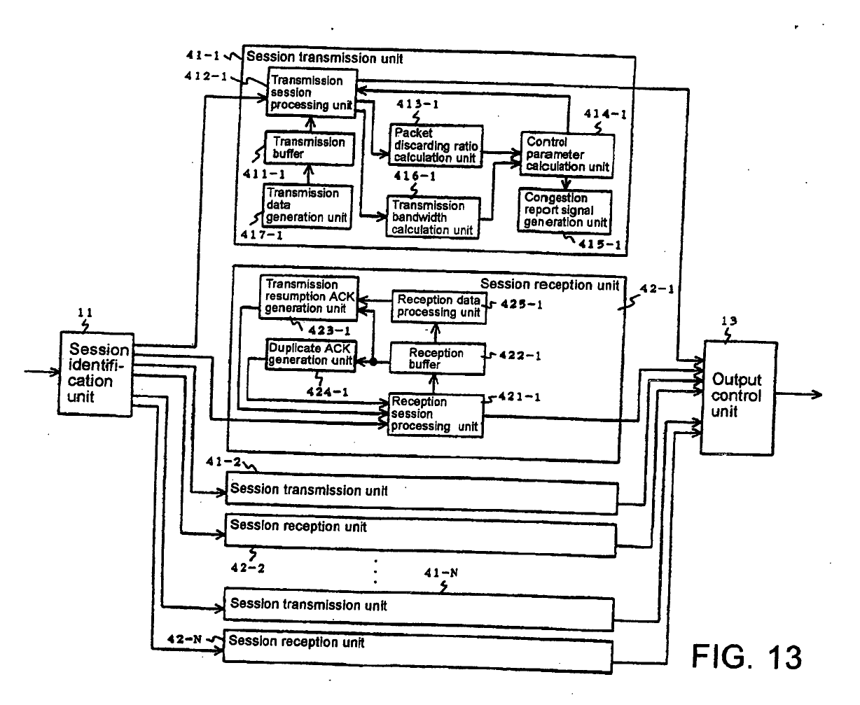

FIG. 13 is a block diagram Illustrating the configuration of a session relay a device according to an eighth embodiment of the present invention. In FIG. 13, the session relay device according to this embodiment comprises session identification unit 11, session transmission units 41-1 to 41-N, session reception units 42-1 to 42-N, and output control unit 13. Session identification unit 11 determines a session to which an incoming packet belongs, session transmission unit 41-1 to 41-N performs transmission processing for data to a session to a reception terminal within a transmission terminal, and session reception unit 42-1 to 42-N performs reception processing for data from a session to the reception terminal within the transmission terminal. Output control unit 13 delivers packets delivered from session transmission units 41-1 to 41-N and session reception units 42-1 to 42-N onto an output line.

Also, session transmission units 41-1 to 41-N comprise transmission data generation units 417-1 to 417-N (transmission data generation units 417-2 to 417-N are not shown); transmission buffers 411-1 to 411-N (transmission buffers 411-2 to 411-N are not shown); transmission session processing units 412-1 to 412-N (transmission session processing units 412-1 to 412-N are not shown); transmission bandwidth calculation units 416-1 to 1416-N (transmission bandwidth calculation units 416-2 to 416-N are not shown); packet discarding ratio calculation units 413-1 to 413-N (packet discarding ratio calculation units 413-2 to 413-N are not shown); control parameter calculation units 414-1 to 414-N (control parameter calculation units 414-2 to 414-N are not shown); and congestion report signal detection units 415-1 to 415-N (congestion report signal detection units 4152 to 415-N are not shown).

Transmission data generation unit 417-1 to 417-N stores transmission data from an application program within the transmission terminal in transmission buffer 411-1 to 411-N, and transmission buffer 411-1 to 411-N temporarily stores data to be transmitted. Transmission session processing unit 412-1 to 412-N processes a session for transmitting data to the reception terminal.

Transmission bandwidth calculation unit 416-1 to 416-N measures a data transmission bandwidth to the reception terminal, packet discarding ratio calculation unit 413-1 to 413-N calculates a packet discarding ratio in a session to the reception terminal, and control parameter calculation unit 414-1 to 414-N changes control parameters for the session to the reception terminal from the transmission bandwidth and packet discarding ratio. Congestion report signal detection unit 41 5-1 to 415-N notifies that a set bandwidth cannot be satisfied due to a congestion in a network.

Session reception units 42-1 to 42-N comprise reception session processing units 421-1 to 421-N (reception session processing units 421-i to 421-N are not shown); reception buffers 422-1 to 422-N (reception buffers 422-2 to 422-N are not shown); received data processing units 425-1 to 425-N (received data processing units 425-2 to 425-N are not shown); transmission resumption ACK generation units 423-1 to 423-N (transmission resumption ACK generation units 423-2 to 423-N are not shown); and duplicate ACK generation units 424-1 to 424-N (duplicate ACK generation units 424-2 to 424-N are not shown).

Reception session processing unit 421-1 to 421-N performs reception processing for data from a reception terminal, and reception buffer 422-1 to 422-N temporarily stores received data. Received data processing unit 425-1 to 425-N passes received data from reception buffer 422-1 to 422-N to an application program. Transmission resumption ACK generation unit 423-1 to a 423-N generates an ACK packet for instructing the reception terminal to resume a transmission, and duplicate ACK generation unit 424-1 to 424-N generates a duplicate ACK for instructing the reception terminal to reduce a transmission rate.

Generally, since bidirectional communications are made between a transmission terminal and a reception terminal in a TCP session, one of session transmission units and one of session reception units are used for a set of a transmission terminal and a reception terminal in this embodiment. Therefore, in this embodiment, the session relay device additionally serves as a transmission terminal or a reception terminal.

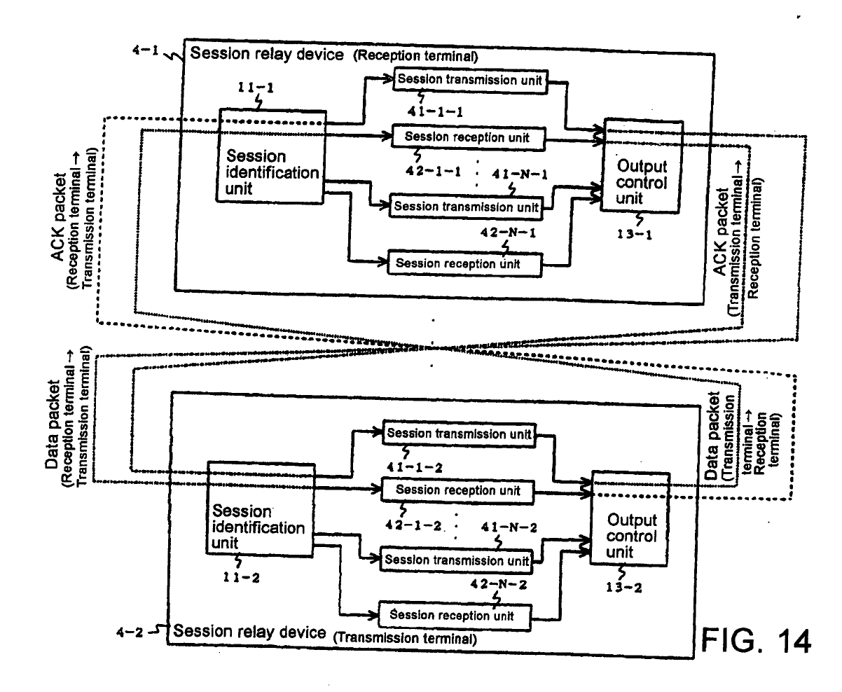

FIG. 14 is a block diagram illustrating a flow of data between the session relay device (transmission terminal) and session relay device (reception terminal) according to the eighth embodiment of the present invention. In FIG. 14, when data Is transmitted from session relay device (transmission terminal) 4-2 to session relay device (reception terminal) 4-1, a data packet delivered from session transmission unit 41-1-2 of session relay device (transmission terminal) 4-2 undergoes reception processing in session reception unit 42-1-1 of session relay device (reception terminal) 4-1. As a result, a generated ACK packet is returned to session transmission unit 41-1-2 of session relay device (transmission terminal) 4-2.

On the other hand, when data is sent from session relay device (reception terminal) 4-1 to session relay device (transmission terminal) 4-2, a data packet delivered from session transmission unit 41-1-1 of session relay device (reception terminal) 4-1 undergoes reception processing in session reception unit 42-1-2 of session relay device (transmission terminal) 4-2. As a result, a generated ACK packet is returned to session transmission unit 41-1-1 of session relay device (reception terminal) 4-1.

Next, the operation of the session relay devices according to the eighth embodiment of the present invention will be described with reference to FIG. 13. First, a description will be given of a data transfer from session relay device (transmission terminal) 4-2 to session relay device (reception terminal) 4-1.

Transmission data generated by an application program is written into transmission buffer 41 1-1 to 411-N by transmission data generation unit 417-1 to 417-N. Transmission session processing unit 412-1 to 412-N performs data transmission processing for data written in transmission buffer 411-1 to 3411-N to session relay device (reception terminal) 4-1. Since this data transmission processing is similar to the aforementioned data transmission processing according to first embodiment of the present invention, a description thereon is omitted. Also, since a change in the control parameters for a session to session relay device (transmission terminal) 4-2 in this embodiment is similar to the fourth embodiment of the present invention described above, a description thereon is also omitted.

Next, a description will be given of a data transfer from session relay device (reception terminal) 4-1 to session relay device (transmission terminal) 4-2.

Received data processing unit 425-1 to 425-N performs reception processing for data transmitted from session relay device (reception terminal) 4-1, and stores data which can be correctly received in reception buffer 422-1 to 422-N. Since this data reception processing is similar to the aforementioned data reception processing according to the first embodiment of the present invention, a description thereon is omitted.

The data written into reception buffer 422-1 to 422-N is retrieved by received data processing unit 425-1 to 425-N, and passed to an application program.

Duplicate ACK generation unit 424-1 to 424-N transmits a sufficient number (generally, “3”) of duplicate AC-K packets in order for the transmission terminal to reduce the congestion window to the transmission terminal when a free capacity of reception buffer 422-1 to 422-N reduces to a certain level or lower, causing the transmission terminal to reduce the data output rate, in a manner similar to the aforementioned first embodiment of the present invention.

On the other hand, when data is moved from reception buffer 422-1 to 422-N to the application program by reception data processing unit 425-1 to 425-N, transmission resumption ACK generation unit 423-1 to 423-N examines reception buffer 422-1 to 422-N for a free capacity, and if the free capacity is equal to or larger than a certain value, generates an ACK packet which is transmitted to the transmission terminal.

Thus, in the present invention, the window flow control is changed for a session between session relay device 1 and reception terminal 2 in session relay device 1 for controlling a communication bandwidth between transmission terminal 3 and reception terminal 2 by relaying sessions between transmission terminal 3 and reception terminal 2, thereby making it possible to improve the throughput between them, and realize the bandwidth control independently of a network congestion situation.

Also, in the present invention, the control parameters can be maintained at appropriate values at all times by, in session relay device 1, monitoring the number of packets staying in the transmission buffer for a session between session relay device 1 and reception terminal 2, and dynamically changing the control parameters based on the number of packets or an average of the number of packets.

Further, in the present invention, the number of packets staying in the reception buffer is monitored in a session between transmission terminal 3 and session relay device 1, and a duplicate ACK having the same ACK sequence number is delivered to transmission terminal 3 when the number of packets or an average of the number of packets is equal to or larger than a certain value, to reduce a transmission rate of transmission terminal 3, thereby making it possible to prevent the reception buffer from frequently being filled up.

Moreover, in the present invention, if a certain amount or more of free capacity can be ensured in the reception buffer at the time an ACK packet is received from reception terminal 2 for confirming the reception of one byte or more, the transmission can be resumed at an earlier stage by transmitting at that time an ACK packet having an advertisement window size of one or more to transmission terminal 3, even if the reception buffer is filled up for a session between transmission terminal 3 and session relay device 1.

In the present invention, the advertisement window size notified from reception terminal 2 is monitored to change the control parameters for a session from session relay device 1 to reception terminal 2 when the averaged advertisement window size is equal to or larger than a certain value, thereby making it possible to reduce a transmission rate from session relay device 1 to prevent the reception buffer from being frequently filled up for the session from session relay device 1 to reception terminal 2.

1. A session relay device for controlling a communication bandwidth between a transmission terminal and a reception terminal by relaying sessions between said transmission terminal and said reception terminal, said session relay device characterized by comprising:
means for changing window flow control for a session between said device itself and said reception terminal.

2. The session relay device according to claim 1, further comprising:
means for monitoring the number of packets staying in a transmission buffer for a session between said device itself and said reception terminal; and
means for dynamically changing a control parameter for the session based on at least the number of packets staying in said transmission buffer.

3. The session relay device according to claim 1, further comprising:
means for monitoring the number of packets staying in a reception buffer for a session between said device itself and said transmission terminal; and
means for delivering a signal for instructing said transmission terminal to reduce a transmission rate when the number of packets staying in said reception buffer or an average value thereof is equal to or larger than a preset certain value.

4. The session relay device according to claim 1, further comprising means for transmitting a signal for advertising an advertisement window size of one or more to said transmission terminal when a free capacity of a preset certain amount or more can be ensured in said reception buffer for receiving a signal for reception confirmation of one byte or more from said reception terminal.

5. The session relay device according to claim 1, further comprising:
means for monitoring an advertisement window size notified from said reception terminal; and
means for changing a control parameter for a session from said device itself to said reception terminal when an average of the advertisement window size is equal to or larger than a preset certain value.

6. A session relay device for realizing a communication between a transmission terminal and a reception terminal by relaying data between a session to said transmission terminal and a session to said reception terminal, said device characterized by comprising:
reception control means for receiving data from the session to said transmission terminal;
transmission control means for transmitting data to the session to said reception terminal;
means for passing data received and processed by said reception control means to said transmission processing means;
observing means for observing a state relating to said transmission control means; and changing means for changing operation of said transmission control means,
wherein the operation of said transmission control means is changed in accordance with a result of the observation of said observing means.

7. The session relay device according to claim 5, wherein said observing means observes at least one of the amount of transmitted data, a transmission bandwidth, a delay, a packet discarding ratio, a retransmission time-out frequency, and the amount of data staying in the transmission buffer as the state relating to said transmission control means.

8. The session relay device according to claim 6, further comprising means for controlling the passing of the data in accordance with at least a target bandwidth and a bandwidth distribution proportion which have been preset between said reception control means and said transmission control means, and changing the operation of said transmission control means in accordance with the amount of data which has not been transmitted in said transmission control means.

9. The session relay device according to claim 8, further comprising means for changing the control parameter of said transmission control means in a direction in which a transmission bandwidth from said transmission control means increases when one of the amount of data which has not been transmitted in said transmission control means or an average thereof increases, and changing the control parameter of said transmission control means in a direction In which the transmission bandwidth from said transmission control means decreases when one of the data amount and the average thereof decreases.

10. The session relay device according to claim 6, further comprising means for changing at least one of the operation and the control parameter of said transmission control means in accordance with a result of a comparison of a set value including at least a preset target bandwidth and bandwidth distribution proportion with a value observed by said transmission control means.

11. The session relay device according to claim 10, further comprising means for changing the control parameter of said transmission control means in a direction in which the transmission bandwidth from said transmission control means increases when the observed value is smaller than the set value, and for changing the control parameter of said transmission control means in a direction in which the transmission bandwidth from said transmission control means decreases when the observed value is larger than the set value.

12. The session relay device according to claim 9, further comprising means for performing a relay between the sessions by directly writing a packet received by said reception control means into a transmission buffer within said transmission control means.

13. The session relay device according to claim 6, further comprising means for changing the control parameter of said transmission control means in a direction in which the transmission bandwidth from said transmission control means decreases either when the transmission bandwidth observed in said transmission control means is equal to or less than a threshold or when a delay, a packet discarding ratio, a retransmission time-out frequency, or the amount of data staying in a transmission buffer observed in said transmission control means is equal to or larger than a preset threshold.

14. The session relay device according to claim 6, further comprising means for notifying a congestion to outside either when a transmission bandwidth observed in said transmission control means is equal to or less than a preset threshold or when a delay, a packet discarding ratio, a retransmission time-out frequency, or the amount of data staying in a transmission buffer observed in said transmission control means is equal to or larger than a preset threshold.

15. The session relay device according to claim 9, further comprising means for either stopping a change in the control parameter or changing a changing width of the control parameter in accordance with an effect of a change in the transmission bandwidth resulting from a change in the control parameter, with reference to a history of changes in the control parameter and a history of changes in the transmission bandwidth by the control parameter.

16. The session relay device according to claim 6, further comprising means for observing either an advertisement window size notified from said reception terminal or an average thereof, wherein the operation of said transmission control means is changed in accordance with a value observed by said means.

17. The session relay device according to claim 16, further comprising means for changing the control parameter of said transmission control means in a direction in which a transmission bandwidth from said transmission control means increases when the observed value has become smaller, and changing the control parameter of said transmission control means in a direction in which the transmission bandwidth from said transmission control means decreases when the observed value has become larger.

18. The session relay device according to claim 6, further comprising means for calculating an elapsed time from the start of a communication on the session, and further comprising means for changing the operation of said transmission control means in accordance with the elapsed time.

19. The session relay device according to claim 18, further comprising means for changing the control parameter of said transmission control means such that the transmission bandwidth from said transmission control means rapidly changes when the elapsed time is short, and for changing the control parameter of said transmission control means such that the transmission bandwidth from said transmission control means slowly changes when the elapsed time is long.

20. The session relay device according to claim 18, wherein a start time of the communication is set at a time after the session has begun to perform a slow start operation in accordance with TCP (Transmission Control Protocol).

21. The session relay device according to claim 6, further comprising, requesting means for requesting to reduce the transmission bandwidth for the session in accordance with a free capacity of a reception buffer for the session,
wherein said requesting means requests to reduce the transmission bandwidth in accordance with either the free capacity of said transmission buffer or an average value thereof before said transmission buffer is depleted of the free capacity.

22. The session relay device according to claim 21, wherein said requesting means requests to reduce the transmission bandwidth by delivering one or more signals for instructing said transmission terminal to reduce a transmission rate.

23. The session relay device according to claim 6, further comprising observing means for observing a free capacity in a reception buffer for the session,
wherein said observing means is triggered by an increase in either the free capacity in said transmission buffer or-an average value thereof to a predefined threshold or higher, to return an acknowledgement signal for the session.

24. The session relay device according to claim 23, wherein said session relay device is triggered by a retrieval of data from said reception buffer to return the acknowledgement signal.

25. The session relay device according to claim 23, wherein said session relay device is triggered by the reception of the acknowledgement signal from a session which relays and transmits data received from the session, to return the acknowledgement signal to a session for receiving the data.

26. The session relay device according to claim 6, wherein said reception control means terminates at least a fourth-layer protocol of TCP (Transmission Control Protocol) to perform data reception processing, and said transmission control means performs data transmission processing using one of the same fourth-layer protocol as said reception control means or a different fourth-layer protocol.

27. A session relay method for a session relay device for controlling a communication bandwidth between a transmission terminal and a reception terminal by relaying sessions between said transmission terminal and said reception terminal, said method characterized by comprising the step of:
changing window flow control for a session between said session relay device and said reception terminal on said session relay device side.

28. The session relay method according to claim 27, further comprising, on said session relay device side, the steps of:
monitoring the number of packets staying in a transmission buffer for a session between said session relay device and said reception terminal; and
dynamically changing a control parameter for the session based on at least the number of packets staying in said transmission buffer.

29. The session relay method according to claim 27, further comprising, on said session relay device side, the steps of:
monitoring the number of packets staying in a reception buffer for a session between said session relay device and said transmission terminal; and
delivering a signal for instructing said transmission terminal to reduce a transmission rate when the number of packets staying in said reception buffer or an average value thereof is equal to or larger than a preset certain value.

30. The session relay method according to claim 27, further comprising the step of transmitting a signal for advertising an advertisement window size of one or more to said transmission terminal when a free capacity of a preset certain amount or more can be ensured in said reception buffer for receiving a signal for reception confirmation of one byte or more from said reception terminal.

31. The session relay method according to claim 27, further comprising the step of monitoring an advertisement window size notified from said reception terminal, and changing a control parameter for a session from said session relay device to said reception terminal when an average of the advertisement window size is equal to or larger than a preset certain value.

32. A session relay method for a session relay device for realizing a communication between a transmission terminal and a reception terminal by relaying data between a session to said transmission terminal and a session to said reception terminal, said method characterized by comprising, on said session relay device side, the steps of:
passing data, which is received and processed by reception control means for receiving data from the session to said transmission terminal, to transmission processing means for transmitting data to a session to said reception terminal;
observing a state relating to said transmission control means; and
changing operation of said transmission control means,
wherein the operation of said transmission control means is changed in accordance with a result of the observation.

33. The session relay method according to claim 32, wherein said step of observing a state relating to said transmission control means further comprises the step of:
observing at least one of the amount of transmitted data, a transmission bandwidth, a delay, a packet discarding ratio, a retransmission time-out frequency, and the amount of data staying in a transmission buffer as the state relating to said transmission control means.
